(19) United States
(12) Patent Application Publication
(10) Pub. No.: US 2010/0070294 A1
(43) Pub. Date: Mar. 18, 2010

(54) CREATING AND COMMUNICATING STAFFING ASSIGNMENTS

(75) Inventors: Charles Christopher Horne, Saint Paul, MN (US); David Paul Carlson, Shoreview, MN (US); Denise Marie Klubertanz, Roseville, MN (US); Pamela Susan-Brustman Freeman, Anoka, MN (US); Murali Mahesh Yakkali, Wheeling, IL (US); Geoffrey Eugene Atkin, Forest Lake, MN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: McKesson Financial Holdings Limited

(21) Appl. No.: 12/210,565

(22) Filed: Sep. 15, 2008

(51) Int. Cl. G06Q 10/00

(52) U.S. Cl. 705/2

(57) ABSTRACT

An automated apparatus, method and system are provided for creating and communicating staffing assignments associated with a plurality of patients receiving treatment in multiple different areas within a healthcare facility and in association with multiple different phases of treatment. In particular, a centralized staff assignment application or module is provided, wherein a staff assignor may access the staff assignment application in order to identify, among other things: (1) staff members capable of facilitating treatment to patients within each area of the healthcare facility; (2) the roles each of those staff members is capable of performing; (3) the peri-operative phase associated with each phase; and (4) the patients scheduled to receive treatment in each of the areas in association with each of the phases. This information may thereafter be used to make staffing assignments, which may be communicated to individuals and applications throughout the healthcare facility.

### FIELD

Embodiments of the invention relate, generally, to the assignment of staff members in association with providing treatment to a plurality of patients within a healthcare facility and, in particular, to an automated method and system for generating and communicating these staffing assignments.

### BACKGROUND

For every patient undergoing surgery, or a similar treatment or procedure within a healthcare facility (e.g., hospital), there are many people (e.g., nurses, physicians, physical therapists, etc.) and things (e.g., rooms, equipment, etc.) that need to be properly assigned in order for the surgery to proceed safely and smoothly. For example, the patient may need to be assigned to a room or bay within the healthcare facility for each of the various phases of his or her peri-operative care. These phases may include, for example, a pre-operative phase (e.g., where the patient's vital signs are tested), a pre-operative holding phase (e.g., where the patient waits to be brought into surgery), an intra-operative phase, and one or more post-operative phases (e.g., where the patient recovers from surgery). Staff members (e.g., nurses, surgeons, physical therapists, anesthesiologists, etc.) may need to be assigned to the patient and/or the various rooms or bays in which the patient may be located. Each staff member may further need to be assigned a role to perform in association with the patient during each of the various phases.

In order to perform these, and other, assignments, knowledge of a vast amount of information may be required. This information may include, for example, which of the different areas within the healthcare facility may be used for each of the different peri-operative phases; what rooms or bays are included within each of those areas; what staff members are capable of or have been assigned to work in each of the different areas; which roles can those staff members perform for each of the different peri-operative phases; which peri-operative phases does the patient require given the procedure or treatment he or she is undergoing or receiving; and/or the like.

Some of the above information may be time-specific. In other words, a factor or assignment may only be valid for a specific span of time and/or on a specific date. For example, a particular area within the healthcare facility may be used for one phase of the peri-operative care one day, or one part of the day, and then for another phase another day, or another part of the same day. It may further, therefore, be beneficial to validate each of the various assignments periodically, such as daily. In addition, the rules and models used by different healthcare facilities, and even by different personnel within these facilities, to make these assignments may vary greatly.

In many instances, the above-referenced assignments may be done manually using a whiteboard placed at a central location within each of the various areas within the healthcare facility. Each white board may include the various assignments associated with each of the different rooms within that physical area including, for example, which patients are being treated in each room within the area, which staff members are assigned to each room and/or patient and/or the like. Several drawbacks exist in association with the use of these whiteboards. For example, as noted above, the whiteboard may only identify the assignments for the physical area in which the whiteboard is located, and not any of the other areas within the healthcare facility. In addition, the whiteboard may only be viewable and available for revising or modifying at a single location within the corresponding physical area. As a result, a single person likely cannot create or revise the assignments associated with multiple physical areas from a single location. Instead, he or she may be required to physically travel between the multiple different physical areas. In addition to being inconvenient, this may prevent that person from using information regarding the assignments in one physical area to assist in making assignments for another physical area where desirable.

A further drawback may be that the assignments illustrated by each whiteboard may not be readily communicated to those in locations other than the corresponding physical area. Communication may require subsequent verbal or written communication from one party to another, which can be time consuming and may result in the inaccurate relaying of information.

A need, therefore, exists for a technique for creating and communicating staffing assignments that addresses at least some of these and other drawbacks and challenges.

### BRIEF SUMMARY

In general, embodiments of the present invention provide an improvement by, among other things, providing an automated method and system for creating and communicating staffing assignments associated with patients receiving treatment in multiple different areas within a healthcare facility and in association with multiple different phases of treatment. In particular, embodiments of the present invention provide a centralized staff assignment application or module which may be accessed by multiple different users at different locations within a healthcare facility in order to generate staffing assignments for the entire healthcare facility.

According to one embodiment, the staff assignment application or module may be configured to enable a user (referred to as a “staff assignor”) to identify and assign staff members including, for example, nurses, surgeons, anesthetists, physical therapists, and/or the like, to different rooms within a healthcare facility used to provide different phases of treatment to a patient, as well as to the different patients themselves by, for example, automatically identifying for the staff assignor the staff members capable of providing treatment to a patient within an area of the healthcare facility selected by the staff assignor, as well as the roles each of those staff members is capable of performing in association with a peri-operative phase also selected by the staff assignor. In addition, the staff assignment application or module may be configured to identify, for the staff assignor, the patients scheduled to receive treatment in each of the areas in association with each of the phases within various time periods or frames defined by the staff assignor. According to embodiments of the present invention, the staff assignment application or module may be configured to provide the foregoing information to the staff assignor to assist in making assignments without having pre-defined and stored a relationship between various areas in the healthcare facility and the various peri-operative phases or a relationship between various staff members and the various peri-operative phases. Accordingly, embodiments of the present invention provide a flexible staff assignment console that permits the foregoing relationships to vary over time.

Embodiments of the present invention may further enable the staff assignment information to be communicated and used by other individuals located at various locations throughout the healthcare facility. For example, according to one embodiment, information regarding the staff members assigned to a patient and/or room associated with a specific phase of treatment may be provided to a user (referred to as a “patient charter”) responsible for documenting the treatment and, in particular, documenting the actual staff members responsible for facilitating the treatment. The patient charter may use the staff assignment information to alleviate some of the burden associated with documenting treatment, since staff assignment information may only need to be modified in the instance when the actual staff member facilitating treatment of the patient is not the same as the staff member assigned to do so.

In addition, according to another embodiment, staff assignment information may further be communicated to a user (referred to as a “patient tracker”) tracking the progress of a patient. The patient tracking information may, therefore, reflect the assigned, or planned, staff member unless and until the patient charter indicates that a different staff member is facilitating the treatment of the patient.

According to one aspect, an apparatus for building a staff assignment module or console is provided. In one embodiment, the apparatus may include a processor configured to: (1) receive and store an identification of one or more staff members capable of facilitating the treatment of a patient within respective areas of a plurality of areas within a healthcare facility; (2) receive and store an identification of one or more of a plurality of roles respective staff members are capable of performing; (3) receive and store an identification of one of a plurality of peri-operative phases of treatment associated with respective roles of the plurality of roles; and (4) generate a staff assignment console based at least in part on the received and stored identifications, said staff assignment console configured to enable a user to assign a staff member to at least one of the plurality of areas and at least one of the plurality of peri-operative phases while permitting an association between respective peri-operative phases and respective areas and an association between respective peri-operative phases and respective staff members to vary dynamically.

According another aspect an apparatus for making staff assignments is provided. In one embodiment, the apparatus may include a processor configured to: (1) receive a selection of one of a plurality of areas within a healthcare facility; (2) identify one or more of a plurality of staff members capable of facilitating the treatment of a patient within the selected area; (3) receive a selection of one of a plurality of peri-operative phases associated with treatment of a patient; and (4) enable a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

In accordance with yet another aspect, a system is provided for making staff assignments. In one embodiment, the system may include one or more user devices and a network entity in electronic communication with the one or more user devices. The network entity may include a processor and a memory in electronic communication with the processor, wherein the memory may store a staff assignment application configured, upon execution, to: (1) receive, from at least one of the one or more user devices, a selection of one of a plurality of areas within a healthcare facility; (2) identify one or more of a plurality of staff members capable of facilitating the treatment of a patient within the selected area; (3) receive, from at least one of the one or more user devices, a selection of one of a plurality of peri-operative phases associated with treatment of a patient; and (4) enable a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

According to one aspect, a method of making staff assignments is provided. In one embodiment, the method may include: (1) receiving a selection of one of a plurality of areas within a healthcare facility; (2) identifying one or more of a plurality of staff members capable of facilitating the treatment of a patient within the selected area; (3) receiving a selection of one of a plurality of peri-operative phases associated with treatment of a patient; and (4) enabling a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

According to another aspect, a computer program product for making staff assignments is provided. In one embodiment, the computer program product may include at least one computer-readable storage medium having computer-readable program code portions stored therein, wherein the computer-readable program code portions may include: (1) a first executable portion for receiving a selection of one of a plurality of areas within a healthcare facility; (2) a second executable portion for identifying one or more of a plurality of staff members capable of facilitating the treatment of a patient within the selected area; (3) a third executable portion for receiving a selection of one of a plurality of peri-operative phases associated with treatment of a patient; and (4) a fourth executable portion for enabling a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram of one type of system that may benefit from embodiments of the present invention;

FIG. 2 is a schematic block diagram of a Central Server according to one embodiment of the present invention;

FIG. 3 is a flow chart illustrating the process of creating staffing assignments in accordance with embodiments of the present invention;

FIG. 4 illustrates a graphical user interface that may be used to create staffing assignments in accordance with embodiments of the present invention;

FIG. 5 is a flow chart illustrating the process of communicating staffing assignments in accordance with embodiments of the present invention; and

FIG. 6 illustrates the interaction between staff assignments and patient charting in accordance with embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overall System and Central Server:

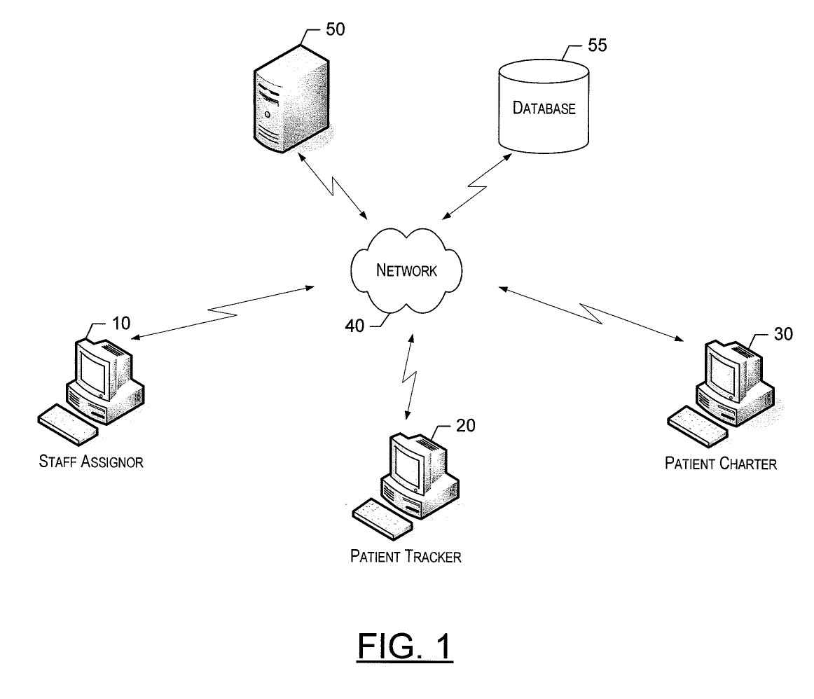

Reference is now made to FIG. 1, which provides a block diagram of one type of system that may benefit from embodiments of the present invention. As shown, the system may include one or more electronic devices (e.g., personal computers (PCs), laptops, personal digital assistants (PDAs), etc.) 10, 20, 30, which may be used, for example, to: (1) assign one or more staff members (e.g., nurses, surgeons, physical therapists, anesthesiologists, etc.) to one or more patients and/or rooms within a healthcare facility (e.g., hospital); (2) complete any necessary documentation associated with the treatment provided to a patient during one or more phases of treatment including, for example, identifying the staff members actually facilitating treatment of the patient (sometimes referred to herein as “charting” the patient's treatment); and/or (3) track a patient's progress throughout his or her treatment within the healthcare facility.

According to one embodiment, as shown, a separate electronic device may be used, for example, by a staff assignor, patient charter and patient tracker, respectively, to perform each of the above-referenced tasks. Accordingly, these electronic devices 10, 20, 30 may be scattered at various locations within the healthcare facility. In addition, multiple different electronic devices may be used to perform the same task. For example, a first PC located in one wing of a hospital may be used to track a surgical patient's progress, while a second PC located in another wing of the hospital may likewise by used to simultaneously track the same or a different patient's progress. Alternatively, or in addition, a single electronic device may be used to perform all, or some combination of, the above-referenced tasks. For example, one of the electronic devices 10, 20, 30 may be used to both assign staff members to various patients and/or rooms within the healthcare facility and chart the treatment of one or more of those patients.

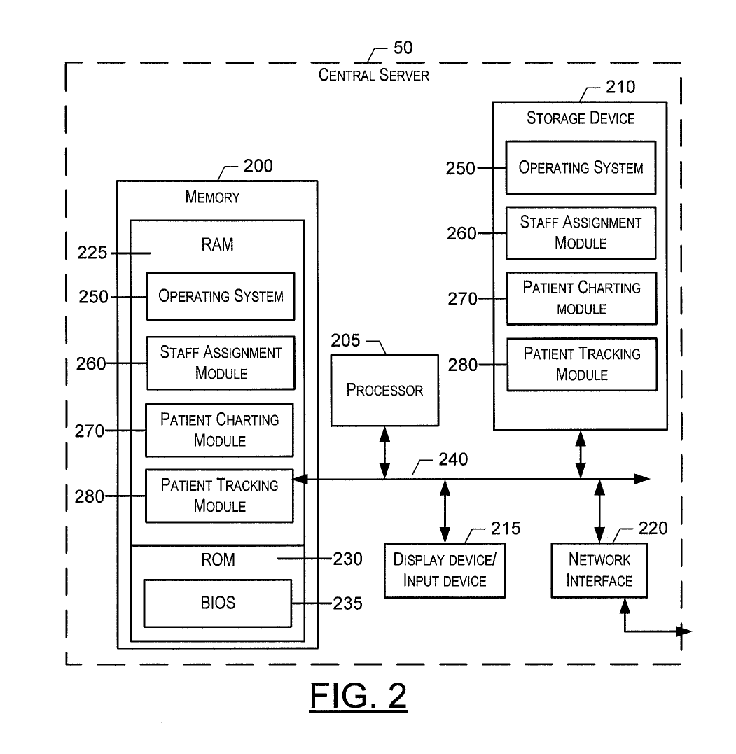

In order to perform any or all of the above-referenced tasks, the electronic devices 10, 20, 30 may be in electronic communication with a central server or computing system 50 over the same or different wireless or wired network 40 including, for example, a wired or wireless Personal Area Network (PAN), Local Area Network (LAN), Wide Area Network (WAN), and/or the like. As discussed in more detail below with regard to FIGS. 2 though 6, the central server, or similar network entity, 50 may, in turn be configured to enable the staff assignor, patient charter and patient tracker in performing their corresponding tasks.

In particular, according to one embodiment, the central server 50 may be configured to receive (e.g., from an electronic device 10 operated by a staff assignor) a selection of an area within a healthcare facility for the purpose of assigning one or more staff members to facilitate the treatment of a patient within the selected area. In response, the central server 50 may be configured to identify one or more staff members capable of facilitating the treatment of the patient within the selected area (e.g., by accessing the database 55, discussed below). The central server 50 may be further configured to receive (e.g., from an electronic device 10 operated by a staff assignor) a selection of one of a plurality of peri-operative phases associated with treatment of a patient and, in response, to enable a user (e.g., the staff assignor) to assign a selected one of the one or more identified staff members to facilitate treatment within the selected area in association with the selected peri-operative phase (e.g., by assigning the selected staff member to a room within the selected area or a patient receiving treatment within the selected area in association with the selected phase). According to one embodiment, the central server 50 may do so independent of any association or relationship between respective areas of the healthcare facility and respective peri-operative phases and independent of any association or relationship between respective peri-operative phases and respective staff members.

As discussed in more detail below, according to another embodiment, the central server 50 may further be configured to provide information identifying the assignment of staff members to a patient charter (i.e., the patient charter's electronic device 20) who is responsible for documenting or recording information regarding the treatment received by a patient, as well as a patient tracker (i.e., the patient tracker's electronic device 30) who is tracking the progress of the patient during the various phases of treatment. The central server 50 may further be configured to receive an indication of the actual staff members assigned to the various patients and/or rooms (e.g., from the patient charter's electronic device 20) and to include an indication of the actual staff members, in conjunction with the indication of the assigned or “planned” staff members, such that the staff assignor may compare the planned and actual assignments and, where appropriate and/or desirable, use this information to make future assignments.

According to one embodiment, the system may further comprise a database 55 associated with or accessible by the central server 50 over the same or different wired or wireless network 40 and storing information that may be used by the central server 50 in performance of the above-referenced tasks. For example, as discussed in more detail below, the database 55 may store, among other things, a listing of the areas within a healthcare facility in which treatment may be provided to a patient, as well as a listing of the rooms associated with each of the different areas. In addition, the database 55 may store a list of one or more roles various staff members may perform in association with providing treatment to a patient within the healthcare facility. These roles may include, for example, chart nurse, circulator, surgeon, and/or scrub technician, to name just a few. According to one embodiment, each role may be assigned to one of a plurality of different peri-operative phases of treatment (e.g., pre-operative or “pre-op,” pre-op holding, intra-operative or “intra-op,” post-operative or “post-op,” etc.) According to one embodiment, the database 55 may further store a listing of the staff members assigned to each of the different areas within the healthcare facility, as well as, for each of those staff members, a listing of the roles he or she is capable of performing. As discussed in more detail below, according to one embodiment, the database 55 may not, however, store a list of one or more areas that are assigned to a particular peri-operative phase, or vice versa, and/or a list of one or more staff members assigned to a particular peri-operative phase, or vice versa. In other words, the relationship between areas and peri-operative phases and between staff members and peri-operative phases may not be specifically defined and stored in the database 55, thus enabling these relationships to vary dynamically over time.

In addition to the foregoing, the database 55 may store information regarding the patients that are receiving treatment within the healthcare facility. According to one embodiment, this information may include, among other things, an indication of the peri-operative phases of the patient's treatment (e.g., whether the patient requires only a single post-op phase, or two, graduated post-op phases including, for example, a first phase in the post-anesthesia care unit), the area and room to which the patient has been assigned for each of these phases, and/or the expected time frame within which the patient will be receiving treatment in each of the various rooms and areas in connection with the different peri-operative phases of treatment.

Referring to FIG. 2, a schematic diagram of Central Server 50 according to one embodiment of the invention is shown. While the foregoing refers to a central “server,” as one of ordinary skill in the art will recognize in light of this disclosure, any central or distributed computing device or network system operating in computer architectures in a client-server architecture or in some other computer architecture may likewise be configured to perform the functionality described herein. Embodiments of the present invention should, therefore not be limited to a single server or to a client-server architecture. Moreover, the designation “central” merely serves to describe the common functionality the server provides for multiple clients or other computing devices and does not require or infer any centralized positioning of the server relative to the other computing devices.

As may be understood from FIG. 2, in this embodiment, the central server 50 may include a processor 205 that communicates with other elements within the central server 50 via a system interface or bus 240. Also included in the central server 50 may be a display device/input device 215 for receiving and displaying data. This display device/input device 215 may be, for example, a keyboard or pointing device that is used in combination with a monitor. A network interface 220, for interfacing and communicating with other elements of a computer network (e.g., the staff assignor's, patient charter's and/or patient tracker's electronic device 10, 20, 30) may also be located within the Central Server 50.

The central server 50 may further include memory 200, which may include both read only memory (ROM) 230 and random access memory (RAM) 225. The server's ROM 230 may be used to store a basic input/output system (BIOS) 235, containing the basic routines that help to transfer information between elements within the central server 50. In addition, the central server 50 may include at least one storage device 210, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 210 may be connected to the system bus 215 by an appropriate interface. The storage devices 210 and their associated computer-readable media may provide nonvolatile storage for a personal computer. It is important to note that the computer-readable media described above could be replaced by any other type of computer-readable media known in the art. Such media may include, for example, magnetic cassettes, flash memory cards, digital video disks, and Bernoulli cartridges.

A number of program modules including, for example, an operating system 250, may be stored by the various storage devices and within RAM 225. According to one embodiment, the central server 50 may store a staff assignment module 260, a patient charting module 270, and a patient tracking module 280, wherein the staff assignment module 260, patient charting module 270, and patient tracking module 280 may each control certain aspects of the operation of the central server 50, with the assistance of the processor 205 and the operating system 250. While the foregoing describes the software of embodiments of the invention in terms of modules by way of example, as one of ordinary skill in the art will recognize in light of this disclosure, the software associated with embodiments of the invention need not be modularized and, instead, may be intermingled or written in other non-modular formats.

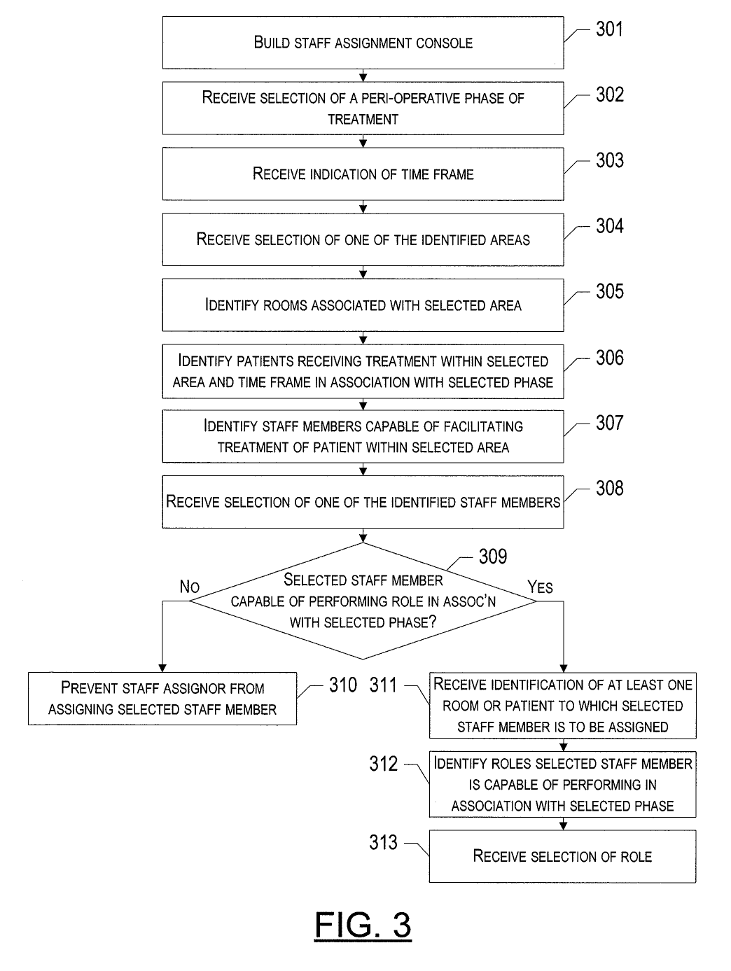

For example, as discussed in more detail below with regard to FIG. 3, according to one embodiment of the present invention, the staff assignment module 260 may, among other things, be configured to receive (e.g., from an electronic device 10 operated by a staff assignor) a selection of an area within a healthcare facility for which the staff assignor desires to assign one or more staff members to facilitate the treatment of a patient within the selected area. In response, the staff assignment module 260 may be configured to instruct the processor 205 to access the database 55 in order to identify one or more staff members capable of facilitating the treatment of the patient within the selected area, and to cause a listing of the identified staff members to be displayed, for example, on a display screen associated with the staff assignor's electronic device 10. The staff assignment module 260 may further configured to receive (e.g., from an electronic device 10 operated by a staff assignor) a selection of one of a plurality of peri-operative phases associated with treatment of a patient and, in response, to enable a user (e.g., the staff assignor) to assign a selected one of the one or more identified staff members to facilitate treatment within the selected area in association with the selected peri-operative phase (e.g., by assigning the selected staff member to a room within the selected area or a patient receiving treatment within the selected area in association with the selected phase). According to one embodiment, the staff assignment module 260 may do so independent of any association or relationship between respective areas of the healthcare facility and respective peri-operative phases and independent of any association or relationship between respective peri-operative phases and respective staff members.

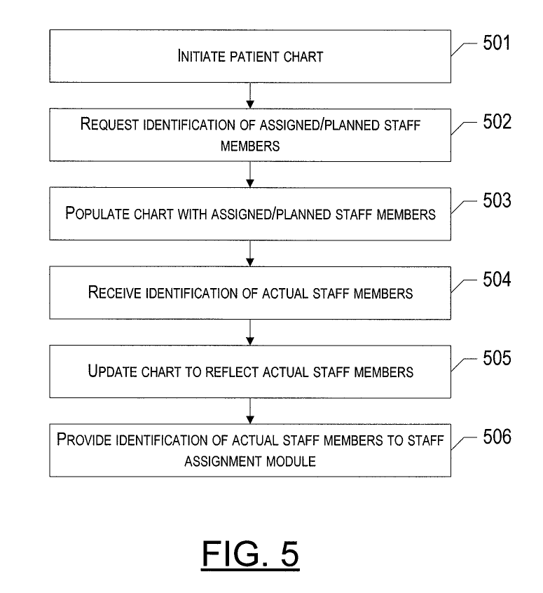

As discussed in more detail below with regard to FIG. 5, the patient charting module 270 may be configured to assist a user (e.g., a patient charter) in documenting the treatment of a patient throughout the various peri-operative phases associated with the patient's treatment including, for example, documenting the staff members actually responsible for providing that treatment. According to one embodiment, this may include, for example, receiving a request from a patient charter's electronic device 20 for an indication of the staff members assigned to the patient, for example, during a particular phase of his or her treatment (e.g., during the pre-op phase) and, in response, instructing the processor 205 to query the database 55 and/or the staff assignment module 260 for the identity of the assigned staff members and to provide the identities received to the patient charter's electronic device 20. The patient charting module 270 may further be configured to receive an indication of the actual staff member(s) assigned to the patient during the various peri-operative phases of treatment (e.g., from the patient charter's electronic device 20) and, as discussed in more detail below, make this information available to the patient tracker's electronic device 30, as well as the staff assignor's electronic device 10.

Finally, the patient tracking module 280 may further be configured to generate and cause to be displayed (e.g., on a display screen associated with the patient tracker's electronic device 30), a timeline associated with the treatment of a patient, wherein the timeline may initially indicate the one or more staff members assigned to the patient by the staff assignor (e.g., via the staff assignment module 260). The patient tracking module 280 may further be configured to receive an indication, for example, from the patient charting module 270, that an actual assignment of a different staff member to the patient and/or room in which the patient received treatment was made, wherein the new staff member is different than one that was originally assigned. In response, the patient tracking module 280 may be configured to instruct the processor 205 to update the timeline to replace the “planned” (or assigned) staff member with the actual staff member.

### Method of Creating Staffing Assignments

Referring now to FIG. 3, the operations are illustrated that may be taken in order to create or generate staff assignments in association with various patients receiving treatment within a healthcare facility (e.g., hospital) in accordance with embodiments of the present invention. According to one embodiment, the process may begin at Block 301 when a user (e.g., an administrator) generates, or builds, the underlying data that may be used, for example, by the staff assignment module 260 being executed by a processor 205 on the central server 50 to assign one or more staff members (e.g., nurses, surgeons, physical therapists, anesthesiologists, etc.) to various patients receiving treatment within the healthcare facility, and/or the rooms in which they will be receiving the treatment, in association with each of a plurality of different peri-operative phases of treatment. As noted above, these phases may include, for example, a pre-operative or “pre-op” phase, wherein the patient may be changing into a hospital gown, having his or her vital signs checked and/or the like; a pre-op holding phase, wherein the patient may be waiting, for example, to be taken into an operating room to undergo surgery; an intra-operative or “intra-op” phase, wherein the patient may be in the operating room undergoing surgery; and one or more post-operative or “post-op” phases including, for example, a post-op phase in a post-anesthesia care unit, wherein the patient may be closely monitored until his or her body has had sufficient time to burn off any anesthesia administered during the surgery.

According to one embodiment, in order to build the underlying data, the administrator, or other user, may first define one or more roles associated with providing treatment to patients within the healthcare facility. These roles may include, for example, acting as the circulator (e.g., person who retrieves items from locations throughout the healthcare facility), scrub technician or nurse (e.g., person who cleans and sterilizes instruments and/or hands various instruments to the physician during a procedure), certified registered nurse anesthetist (CRNA), licensed practical nurse (LPN), surgeon, and/or the like, just to name a few. In order to define the roles, the administrator may use his or her electronic device to input, and the central server 50 (e.g., the processor 205 operating on the central server 50) may receive, the name or title of the role and an identification of the peri-operative phase of treatment (e.g., pre-op, intra-op, post-op, etc.) associated with that role. Upon receipt, the central server 50 (e.g., processor 205) may create and store a table of roles (and corresponding peri-operative phases) in the database 55.

The administrator, or other user, may further define one or more different areas within the healthcare facility in which treatment may be provided. These areas may include, for example, a surgical area, an outpatient area, and/or the like. In order to define the areas, the administrator may use his or her electronic device to input, and the central server 50 (e.g., the processor 205) may receive, the name of each of the different areas and, according to one embodiment, an identification of one or more rooms within each area (e.g., operating room (OR) 1, OR2, etc.) Upon receipt, the central server 50 (e.g., processor 205) may store the list of areas and corresponding roles in the database 55.

In addition, according to one embodiment, in order to build the data which may be used by the staff assignment module 260 in order to assign staff members to various patients and/or rooms within a healthcare facility, the administrator, or other user, may further identify the various staff members associated with the healthcare facility. In particular, according to one embodiment, the administrator, or other user, may use his or her electronic device to input, and the central server 50 (e.g., processor 205) may receive, an identification of each of the staff members associated with the healthcare facility, an identification of the areas in which each staff member is capable of providing treatment (e.g., surgical area, outpatient area, etc.), as well as an identification of the roles he or she is capable of performing (e.g., nurse, surgeon, scrub nurse, etc.). Upon receipt, the central server 50 (e.g., processor 205) may create and store a table of staff members (and corresponding areas and roles) in the database 55.

Based on the foregoing, according to embodiments of the present invention, prior to commencing with the actual assignments of staff members to patients receiving treatment within a healthcare facility and/or the rooms in which they are receiving treatment, several pieces of information associated with the healthcare facility may be defined and stored, for example, in the database 55. These may include a linking, or assignment, of staff members to various areas within the healthcare facility; a linking, or assignment, of staff members to various roles performed within the healthcare facility; and a linking, or assignment, of roles to a corresponding peri-operative phase of treatment.

Notably, the information defined (or the data built) prior to commencing with actual staff assignments may not include a linking, or assignment, of staff members to various peri-operative phases of treatment or a linking, or assignment, of areas within the healthcare facility to various peri-operative phases of treatment. In other words, according to one embodiment of the present invention, an administrator need not specifically define in which areas of the healthcare facility different peri-operative phases of treatment will be provided, nor does the administrator need to specifically define which staff members are assigned to provide the treatment associated with each of the different peri-operative phases of treatment. As a result, in addition to reducing the amount of up front work needed to be performed in order to generate and provide the staff assignment console, these relationships (i.e., between peri-operative phases of treatment and areas or staff members) may be permitted to vary over time.

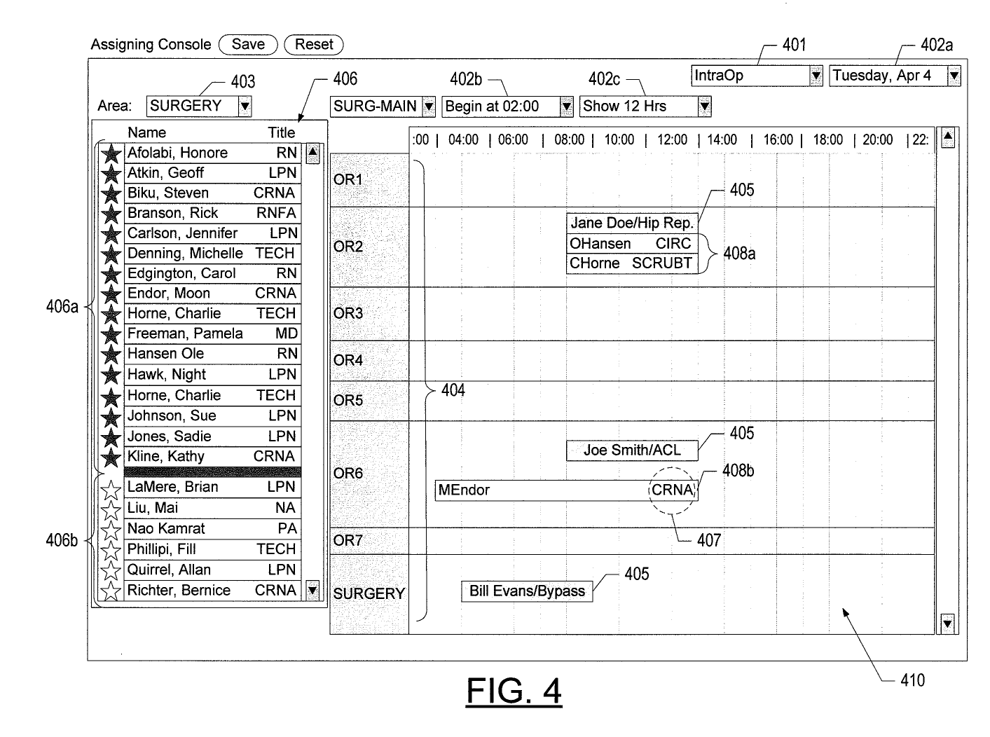

Returning to FIG. 3, once the above-referenced in formation has been defined (data has been built) in association with a particular healthcare facility, a user (e.g., a “staff assignor”) may use his or her electronic device (e.g., personal computer (PC), laptop, personal digital assistant (PDA), etc.) 10 to access the central server 50 and, in one embodiment, the staff assignment module 260 being executed by a processor 205 on the central server 50, in order to assign one or more staff members to various patients receiving treatment within the healthcare facility, and/or the rooms in which they will be receiving treatment, in association with each of a plurality of different peri-operative phases of treatment. Upon accessing the central server 50/staff assignment module 260, the user may first be asked to select a peri-operative phase, the time frame or period, and the area within the healthcare facility for which he or she would like to begin making staff assignments. The central server 50/staff assignment module 260 may receive the user's selection of a phase, time frame and area at Blocks 302, 303 and 304, respectively. To illustrate, reference is made to FIG. 4, which provides an example of a graphical user interface which may be provided by the central server 50/staff assignment module 260 (e.g., via the staff assignor's electronic device 10) for use by the staff assignor in creating and generating staff assignments in accordance with embodiments of the present invention. As shown in FIG. 4, the user in this example has selected the “IntraOp” phase 401 and, with regard to the time frame, Tuesday, April 4 402a beginning at 02:00 402b and continuing for the next 12 hours 402c. In addition, according to the embodiment shown in FIG. 4, the user may use a drop down menu 403 to access a list of areas within the healthcare facility and to select the desired area which, in the example shown, is “SURGERY.”

In response to receiving the selection of an area for which the user (e.g., the staff assignor) would like to assign one or more staff members in association with the selected peri-operative phase, the central server 50/staff assignment module 260 may access the database 55 in order to identify the one or more rooms located within the selected area (Block 305) and the one or more patients scheduled to receive treatment within those rooms during that time period (Block 306). The central server 50/staff assignment module 260 may thereafter generate and display (e.g., on a display device associated with the staff assignor's electronic device 20) a grid 410 that may be used to assign staff members to the identified rooms and/or patients. As shown in FIG. 4, according to one embodiment, the grid 410 may include a row 404 corresponding to each identified room within the selected area (e.g., operating room 1 (OR1), OR2, OR3, OR4, OR5, OR6, OR7 and SURGERY), and a column for each of a plurality of time periods within the selected time frame (e.g., each hour within the 12 hours beginning at 02:00 on Tuesday, April 4^{th}). Once created, the central server 50/staff assignment module 260 may populate the grid 410 with some or all of the information obtained with respect to each of the patients receiving treatment in one of the rooms during the designated time frame in association with the selected peri-operative phase. In particular, according to one embodiment, the central server 50/staff assignment module 260 may cause the patient's name and the procedure he or she is receiving to be displayed within the row and column corresponding to the room and time period, respectively, in which the patient is scheduled to receive the selected phase of treatment. For example, patient Jane Doe may be scheduled to undergo hip replacement surgery (i.e., in the intra-operative phase of treatment) in OR 2 between 8:00 AM and 1:00 PM on April 4^{th}. As a result, a patient designator 405 associated with Jane Doe labeled “Jane Doe/Hip Rep.” may be displayed on the grid 410 within the row corresponding to OR2 and within the columns corresponding to 08:00 to 13:00.

The central server 50/staff assignment module 260 may, at Block 307 identify the staff members that are capable of facilitating, or assigned to facilitate, the treatment of a patient within the selected area and provide the user (e.g., staff assignor) with a list of the identified staff members 406, from which the user may select. According to one embodiment, the central server 50/staff assignment module 260 may identify the staff members by accessing the database 55, which, as noted above, may store a mapping of one or more staff members to each of the different areas within the healthcare facility in which the staff members are capable of working and/or assigned to work. According to one embodiment, each staff member may be capable of facilitating treatment of a patient in one or more different areas and multiple staff members may be capable of facilitating treatment of a patient in the same area.

Referring to FIG. 4, according to one embodiment, the list 406 provided to the staff assignor may further designate, of the staff members capable of facilitating treatment of a patient within the selected area, which are scheduled to work during the designated time frame (e.g., included in the top of the list 406a) and which are not (e.g., included in the bottom of the list 406b). According to one embodiment, the central server 50/staff assignment module 260 may automatically determine the status of the identified staff members and provide this designation to the user (e.g., by including each staff member in the top or bottom of the list depending upon his or her status in relation to the selected time frame). Alternatively, the staff assignor may manually designate which of the identified staff members are scheduled to work during the selected time frame by, for example, moving the staff members up and down within the list provided.

According to another embodiment, the list of staff members 406 displayed on the staff assignor's electronic device by the central server 50/staff assignment module 260 may include all of the staff members associated with the healthcare facility, while differentiating in some manner those that are identified as being capable of facilitating treatment of a patient within the selected area. For example, the identified staff members may be included in the top portion of the list 406a, while the remaining staff members who have not been identified as being capable of facilitating treatment of a patient within the selected area may be included in the bottom portion of the list 406b. By providing the staff assignor with a list of all of the staff members within the healthcare facility, and not just those identified as being capable of facilitating treatment of a patient within the selected area, this embodiment may enable the staff assignor to override the previously designated limitations of a staff member and assign him or her to a patient or room within an area for which the staff member was not originally designated.

Upon reviewing the list of identified staff members, the staff assignor may select one of the identified staff members and assign the staff member to a patient receiving treatment or a room within the selected area. In particular, according to one embodiment, the staff assignor may first select, and the central server 50/staff assignment module 260 may receive a selection of, one of the identified staff members. (Block 308). Upon receipt of the selection, the central server 50/staff assignment module 260 may determine, at Block 309, whether the selected staff member is capable of performing a role that is associated with the selected peri-operative phase of treatment. In particular, as described above, according to one embodiment, the database 55 may store a list of each of the roles a staff member is capable of performing, as well as an identification of a peri-operative phase associated with each of the various roles. The central server 50/staff assignment module 260 may use this information to determine if, in fact, the selected staff member can perform a role associated with the assignments currently being made (i.e., associated with the peri-operative phase selected by the staff assignor at Block 302 above).

If it is determined that the selected staff member cannot perform at least one role that is associated with the selected peri-operative phase, the central server 50/staff assignment module 260 may prevent the staff assignor from assigning the selected staff member to a patient and/or room. (Block 310). For example, the central server 50/staff assignment module 260 may prevent the staff assignor from dragging the selected staff member's name displayed within the list of identified staff members 406 and dragging the name to the displayed grid 410.

If, on the other hand, it is determined that the selected staff member can perform at least one role associated with the selected peri-operative phase, the process may proceed to Block 311 where the staff assignor may select, and the central server 50/staff assignment module 260 may receive a selection of, a patient receiving treatment or a room within the selected area. As suggested above, according to one embodiment, in order to assign a selected staff member to a patient or room, the staff assignor may select the staff member's name displayed within the list of identified staff members 406, drag the selected name to the displayed grid 410, and drop the selected name proximate the location at which the corresponding patient's designator 405 is displayed or within the row associated with the desired room. Upon releasing the selected staff member's name, a designator associated with the staff member 408a, 408b may be displayed within the grid 410 either adjacent the patient to whom the staff member has been assigned (e.g., staff designator 408a), or within the row associated with the room to which the staff member has been assigned (e.g., staff designator 408b).

For example, referring to FIG. 4, by selecting staff members Ole Hansen and Charlie Home from the list of staff members 406, dragging their names to the grid 410, and dropping them proximate the location at which Jane Doe's patient designator 405 is displayed, the staff assignor has indicated his or her desire to assign Hansen and Home to Doe. As a result, the central server 50/staff assignment module 260 may create a staff designator associated with both Hansen and Home 408a and display these designators 408a adjacent Jane Doe's patient designator 405. Similarly, by selecting staff member Moon Endor from the list of staff members 406, dragging Endor's name to the grid 410, and dropping it within the row corresponding to OR6, the staff assignor has indicated his or her desire to assign Endor to OR6. As a result, the central server 50/staff assignment module 260 may create a staff designator associated with Endor 408b and display the designator 408b within the row corresponding to OR6.

Returning to FIG. 3, after assigning a staff member to a patient or room, the staff assignor may then assign the staff member a role to perform in relation to that patient or room. In particular, according to one embodiment, the staff assignor may request to view a list of the roles an assigned staff member is capable of performing in relation to the corresponding patient or room. In order to request the list of possible roles associated with an assigned staff member, the staff assignor may click on, or otherwise select, the staff designator 408a, 408b associated with that staff member.

In response to receiving the request, the central server 50/staff assignment module 260 may, at Block 312, identify which roles the selected staff member is capable of performing in relation to the selected peri-operative phase. In order to do so, the central server 50/staff assignment module 260 may access the database 55, which, as discussed above, may include a list of the roles each staff member is capable of performing, as well as an identification of the peri-operative phase associated with each role. The database 55 may further store a designation of the selected staff member's primary role. The central server 50/staff assignment module 260 may filter the list of roles the staff member is capable of performing based on the selected peri-operative phase in order to identify those roles the staff member is capable of performing in association with the selected peri-operative phase. Upon identifying the appropriate roles, the central server 50/staff assignment module 260 may display the identified roles, for example, in a drop down menu associated with the staff member's designator 408a, 408b. The staff assignor may then select one of the identified roles (e.g., from the displayed drop down menu), wherein the central server 50/staff assignment module 260 may receive this selection at Block 313. Upon receiving the selection of a role for the assigned staff member, according to one embodiment, the central server 50/staff assignment module 260 may modify the staff member's designator 408a, 408b to include a reference to the assigned role 407. In addition, or alternatively, the central server 50/staff assignment module 260 may modify the color associated with the staff designator in order to reflect the assigned role (e.g., all circulators may be shown in green, all CRNAs may be shown in blue, etc.)

According to embodiments of the present invention, a staff assignor may repeat the above-referenced steps in order to assign staff members to patients receiving treatment in each of the various different peri-operative phases and in each of the different areas of the healthcare facility associated with those phases, as well as to each of the various rooms located in each of the various areas.

According to one embodiment, once the staff assignor has assigned one or more staff members to a patient or room, the central server 50/staff assignment module 260 may review the assignments made in order to determine whether any conflicts exist and, if a conflict is identified, modify the designators of the staff member(s) involved in the conflict to reflect that a conflict exists. For example, if the central server 50/staff assignment module 260 determines that Kathy Kline has been assigned as the CRNA for OR1 between noon and 4:00 PM and OR5 between 2:00 PM and 6:00 PM and, therefore, that a conflict exists for Kline between 2:00 PM and 4:00 PM (since Kline cannot be in two operating rooms at one time), the central server 50/staff assignment module 260 may modify Kline's designator (e.g., by underlining Kline's name in red) to indicate that a conflict exists.

While the foregoing provides an example of the process that may be performed in order to generate staff assignments, the order described above of the steps performed in relation to that process is provided for exemplary purposes only and should not be taken in any way as limiting the scope of embodiments of the present invention to the particular order provided. Alternatively, as one of ordinary skill in the art will recognize in light of this disclosure, the foregoing steps may be preformed in multiple different orders and combinations without departing from the spirit and scope of embodiments of the present invention.

### Method of Communicating/Sharing Staffing Assignments

According to embodiments of the present invention, once the staff assignor has created the staff assignments for various patients and/or rooms associated with various peri-operative phases of treatment, areas within the healthcare facility and/or time frames, the assigned or “planned” staffing information may be made available to other parties operating within the healthcare facility, for example, for the purpose of documenting the treatment provided to a patient (referred to as “charting” the patient's treatment), and/or for tracking the patient's progress throughout his or her treatment.

To illustrate, reference is now made to FIG. 5, which illustrates the process that may be performed by a user responsible for documenting, or charting, a patient's treatment (referred to hereinafter as a “patient charter”). As shown in FIG. 5, the process may begin at Block 501, when a patient charter uses his or her electronic device 20 to access the central server 50 and, in one embodiment, the patient charting module 270 executed by a processor 205 on the central server 50 in order to initiate the creation of a chart associated with a particular peri-operative phase of treatment received by a patient (e.g., to document the pre-operative treatment received by the patient). In order to facilitate creation of the chart, the patient charter may, at Block 502, request an identification of the staff members who have been assigned to the patient for that peri-operative phase and/or to the room in which the patient will be receiving the treatment. In one embodiment, the patient charter may do so by using his or her electronic device 20 to transmit a request to the central server 50/patient charting module 270, which may, in turn retrieve the information, for example, from the database 55 or via a request to the staff assignment module 260 executing on the central server 50.

The central server 50/patient charting module 270 may, at Block 503, upon determining the assigned (or planned) staff members, populate the patient's chart with the assigned staff members. Embodiments of the present invention may, therefore, save the patient charter significant time in inputting the staff members responsible for providing treatment to a patient, assuming that many of the assigned, or planned, staff members end up actually facilitating the treatment of the patient.

At some point thereafter, the patient charter may begin to input the identification of the actual staff members responsible for facilitating treatment of the patient using his or her electronic device 20. The central server 50/patient charting module 270 may receive the identification of the actual staff members and use the information received to update the patient's chart at Blocks 504 and 505, respectively. In particular, if one or more of the actual staff members responsible for providing treatment to the patient differ from those that were assigned, or planned, the actual staff members may replace the planned staff members initially included in the patient's chart. In addition, according to one embodiment, the identity of the actual staff members may further, at Block 505, be provided to the staff assignment module 260 in order to incorporate this information into the information available to the staff assignor (e.g., the information seen by the staff assignor via the graphical user interface displayed in FIG. 4). According to one embodiment, the staff assignor may use this information to assist in making future assignments.

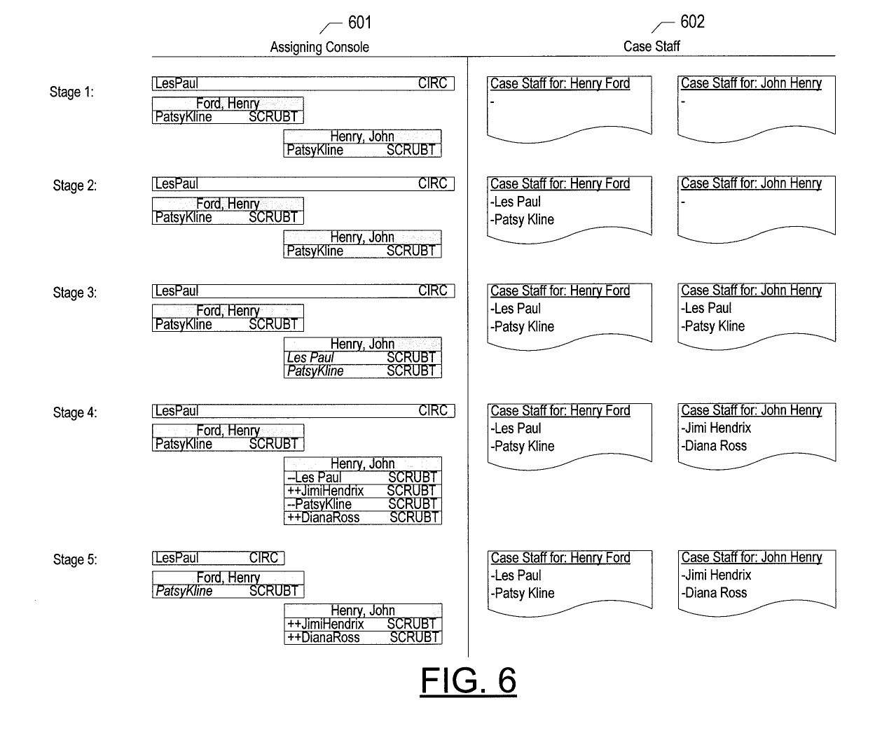

To illustrate, reference is made to FIG. 6 which provides an example of what may be seen by a staff assignor (e.g., the “Assigning Console” 601 displayed on the left-hand side of FIG. 6) and a patient charter (e.g., the “Case Staff” 602 displayed on the right-hand side of FIG. 6), respectively, on his or her electronic device 10, 20 as two patients receive treatment and their treatment is charted. The patient and staff designators illustrated within the Assigning Console may correspond to the patient designators 405 and staff designators 408a, 408b illustrated and described above with reference to the grid 410 provided by the graphical user interface of FIG. 4 used to create staffing assignments.

As shown, at Stage 1, the staff assignor may have assigned (e.g., in the manner described above) Les Paul as the circulator for the room in which both Henry Ford and John Henry will receive treatment. In addition, Patsy Kline may have been assigned as the scrub technician for each of these patients. The patient charter has not yet begun to chart either patient's treatment at this stage.

At Stage 2, the patient charter may begin to chart the treatment of Henry Ford. As a result, Henry Ford's chart may be initially populated with the staff members assigned to Henry Ford and the room in which he is receiving treatment (i.e., Patsy Kline and Les Paul). Assuming, as is the case in this example, that Les Paul and Patsy Kline are in fact the actual staff members responsible for facilitating the treatment of Henry Ford, the patient charter may not need to modify Henry Ford's chart at any point thereafter. Accordingly, as shown, Henry Ford's chart may continue to display Les Paul and Patsy Kline throughout the remaining stages discussed.

This may not be the case, however, for John Henry's chart. In particular, at Stage 3, John Henry may begin to receive treatment, and the patient charter may begin to chart this treatment. Similar to Henry Ford, John Henry's chart may be initially populated with the staff members assigned to provide treatment to John Henry (i.e., Les Paul and Patsy Kline). However, because, in this example, treatment of John Henry has begun prior to the conclusion of treatment of Henry Ford, Les Paul and Patsy Kline may not be available to facilitate treatment of John Henry, as planned. As shown, according to one embodiment, an indication that the assigned staff member (i.e., Les Paul and Patsy Kline) is not available to facilitate treatment of a patient to which the staff member has been assigned may be provided to the staff assignor, for example, by modifying the staff designator 408a, 408b displayed to the staff assignor. For example, in one embodiment shown in FIG. 6, the staff member's name included within the staff designator may be italicized.

As a result of the assigned, or planned, staff members being unavailable, the patient charter may, at Stage 4, update John Henry's chart to replace the assigned staff members initially included in his chart with the actual staff members who will be/are facilitating treatment of John Henry (i.e., Jimi Hendrix and Diana Ross). John Henry's chart may now reflect the actual staff members associated with his treatment. In addition, as shown in the Assigning Console 601 at Stage 4, the staff assignor's user interface may further be modified to include a reference to the actual staff members associated with the patient/room. For example, as shown, according to one embodiment, the staff designators associated with planned staff members who are not available (i.e., Les Paul and Patsy Kline) may continue to be displayed, but may be modified to include, for example, a “−−” sign, indicating that the staff member did not actually provide the treatment. In addition, a staff designator associated with the actual staff members (i.e., Jimi Hendrix and Diana Ross) may be added with a “++” sign, indicating that they were nor initially assigned, but actually facilitated performance of the treatment.

According to one embodiment, the staff assignor may then, at Stage 5, update the staffing assignments included in the grid 410 to reflect the actual assignments, as opposed to the planned assignments. In particular, as shown, the staff assignor may shorten the room assignment associated with Les Paul, and remove Patsy Kline altogether from the assignments to John Henry.

In addition to the foregoing, according to one embodiment of the present invention, information regarding the assigned (or planned) and actual staff assignments may further be used to provide patient tracking information depending upon whether it is before the patient's chart has been prepared or after. For example, according to one embodiment, a user (referred to hereinafter as a “patient tracker”) may use his or her electronic device 30 to access the central server 50 and, in one embodiment, the patient tracking module 280 executed by a processor 205 on the central server 50 in order to track a patient's progress throughout the various peri-operative phases of his or her treatment.

According to one embodiment, the patient tracking information provided to the patient tracker may include, among other things, an indication of the staff members associated with providing treatment to the patient during the various phases. According to one embodiment, prior to the patient charter commencing documentation of a patient's treatment in association with a particular phase, the central server 50/patient tracking module 280 may pull this information from the staff assignment module 260. In other words, the patient tracking information may reflect the staff members assigned to or planned for the patient and/or the room in which he or she is receiving treatment.

In contrast, after the patient charter commences documentation, or charting, the patient's treatment, the central server 50/patient tracking module 280 may switch to the patient charting module 270 for information regarding the staff members actually providing treatment to the patient. In other words, after commencing charting a patient's treatment, tracking information associated with the patient may include the actual staff members associated with the patient, rather than the assigned, or planned, staff members (assuming they are different).

### CONCLUSION

As described above and as will be appreciated by one skilled in the art, embodiments of the present invention may be configured as a system, method or apparatus. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 205 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 205 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
a processor configured to:
receive and store an identification of one or more staff members capable of facilitating the treatment of a patient within respective areas of a plurality of areas within a healthcare facility;
receive and store an identification of one or more of a plurality of roles respective staff members are capable of performing;
receive and store an identification of one of a plurality of peri-operative phases of treatment associated with respective roles of the plurality of roles; and
generate a staff assignment console based at least in part on the received and stored identifications, said staff assignment console configured to enable a user to assign a staff member to at least one of the plurality of areas and at least one of the plurality of peri-operative phases while permitting an association between respective peri-operative phases and respective areas and an association between respective peri-operative phases and respective staff members to vary dynamically.

2. An apparatus comprising:
a processor configured to:
receive a selection of one of a plurality of areas within a healthcare facility;
identify one or more of a plurality of staff members capable of facilitating the treatment of a patient within the selected area;
receive a selection of one of a plurality of peri-operative phases associated with treatment of a patient; and
enable a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

3. The apparatus of claim 2, wherein in order to enable a user to assign a selected one of the one or more identified staff members to facilitate treatment within the selected area in association with the selected peri-operative phase, the processor is further configured to:
identify one or more of a plurality of roles associated with the selected peri-operative phase;
determine which of the one or more identified roles the selected staff member is capable of performing; and
enable the user to assign the selected staff member to facilitate treatment within the selected area in association with the selected peri-operative phase, only if it is determined that the selected staff member is capable of performing at least one of the one or more identified roles associated with the selected peri-operative phase.

4. The apparatus of claim 3, wherein the processor is further configured to:
enable the user to assign one of the one or more identified roles to the selected staff member.

5. The apparatus of claim 2, wherein in order to enable a user to assign a selected one of the one or more identified staff members to facilitate treatment within the selected area in association with the selected peri-operative phase, the processor is further configured to:
receive an identification of at least one of a room within the selected area or a patient receiving treatment within the selected area to which the selected staff member is to be assigned.

6. The apparatus of claim 5, wherein the processor is further configured to:
receive an indication of a time frame for which one or more of the plurality of staff members are to be assigned to facilitate treatment within the selected area in association with the selected peri-operative phase.

7. The apparatus of claim 6, wherein the processor is further configured to:
identify one or more patients receiving treatment within the selected area, in association with the selected peri-operative phase, and within the selected time frame, wherein in order to receive an identification of a patient receiving treatment within the selected area to which the selected staff member is to be assigned, the processor is further configured to receive a selection of one of the one or more identified patients.

8. The apparatus of claim 5, wherein the processor is further configured to:
cause the display of an indication identifying the selected staff member as assigned to the room or patient.

9. The apparatus of claim 8, wherein the processor is further configured to:
receive an indication of an actual assignment of a different staff member to the room or patient associated with the selected staff member; and
generate, and cause to be displayed, in conjunction with the indication identifying the selected staff member as assigned to the room or patient, a second indication identifying the actual staff member assigned to the room or patient.

10. The apparatus of claim 8, wherein the processor is further configured to:
generate, and cause the display of, a timeline associated with the treatment of a patient, said timeline comprising one or more staff members assigned to the patient, one or more rooms in which the patient is to receive treatment, or both, wherein the one or more staff members initially comprise the selected staff member;
receive an indication of an actual assignment of a different staff member to the patient or room associated with the selected staff member; and
update the timeline in order to replace the selected staff member with the actual staff member, wherein the previously displayed indication identifying the selected staff member as assigned to the room or patient remains unchanged.

11. A system comprising:
one or more user devices; and
a network entity in electronic communication with the one or more user devices, said network entity further comprising:
a processor; and
a memory in electronic communication with the processor, said memory storing a staff assignment application configured, upon execution, to:
receive, from at least one of the one or more user devices, a selection of one of a plurality of areas within a healthcare facility;
identify one or more of a plurality of staff members capable of facilitating the treatment of a patient within the selected area;
receive, from at least one of the one or more user devices, a selection of one of a plurality of peri-operative phases associated with treatment of a patient; and
enable a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

12. The system of claim 11 further comprising:
a database in electronic communication with the network entity, said database storing a mapping of respective areas of a plurality of areas within a healthcare facility to one or more staff members capable of facilitating the treatment of a patient within the corresponding area, wherein in order to identify one or more of the plurality of staff members, the staff assignment application is further configured, upon execution, to access the mapping stored in the database to identify the one or more staff members.

13. The system of claim 12, wherein the database further stores a mapping of respective staff members of the plurality of staff members to one or more roles the corresponding staff member is capable of performing, and a mapping of respective roles to one of the plurality of peri-operative phases, and wherein the database does not store a mapping of one or more areas of the plurality of areas to one or more peri-operative phases of the plurality of peri-operative phases or a mapping of one or more staff members of the plurality of staff members to one or more peri-operative phases.

14. The system of claim 13, wherein in order to enable a user to assign a selected one of the one or more identified staff members to facilitate treatment within the selected area in association with the selected peri-operative phase, the staff assignment application is further configured to:
identify one or more of a plurality of roles associated with the selected peri-operative phase;
determine which of the one or more identified roles the selected staff member is capable of performing;
enable the user to assign the selected staff member to facilitate treatment within the selected area in association with the selected peri-operative phase, only if it is determined that the selected staff member is capable of performing at least one of the one or more identified roles associated with the selected peri-operative phase.

15. The system of claim 11, wherein in order to enable a user to assign a selected one of the one or more identified staff members to facilitate treatment within the selected area in association with the selected peri-operative phase, the staff assignment application is further configured, upon execution, to:
receive an indication of at least one of a room within the selected area or a patient receiving treatment within the selected area to which the selected staff member is to be assigned.

16. The system of claim 15, wherein the database further stores, for respective patients of a plurality of patients receiving treatment within the healthcare facility, an indication of an area, and a room within the area, in which the patient is to receive treatment in association with respective peri-operative phases of the plurality of peri-operative phases, said database further storing for respective patients of the plurality of patients, a time period within which the patient is to receive treatment associated with respective peri-operative phases of the plurality of peri-operative phases.

17. The system of claim 16, wherein the staff assignment application is further configured, upon execution, to:
receive an indication of a time frame for which one or more staff members are to be assigned to facilitate treatment of a patient within the selected area in association with the selected peri-operative phase; and
access the database in order to identify one or more patients receiving treatment within the selected area, in association with the selected peri-operative phase, and within the selected time frame, wherein in order to receive an identification of a patient receiving treatment within the selected area to which the selected staff member is to be assigned, the staff assignment application is further configured, upon execution, to receive a selection of one of the one or more identified patients.

18. The system of claim 15, wherein the staff assignment application is further configured, upon execution, to:
cause the display of an indication identifying the selected staff member as assigned to the room or patient.

19. The system of claim 18, wherein the staff assignment application is further configured, upon execution, to:
receive, from at least one of the one or more user devices, an indication of an actual assignment of a different staff member to the room or patient associated with the selected staff member; and
generate, and cause to be displayed, in conjunction with the indication identifying the selected staff member as assigned to the room or patient, a second indication identifying the actual staff member assigned to the room or patient.

20. The system of claim 19, wherein in order to receive an indication of an actual assignment, the staff assignment application is further configured, upon execution, to receive the indication from a first user device, and wherein in order to generate, and cause to be displayed, a second indication, the staff assignment application is further configured, upon execution, to cause the second indication to be displayed on a second user device different from the first user device.

21. The system of claim 18, wherein the memory further stores a patient tracking application configured, upon execution, to:
generate, and cause the display of, a timeline associated with the treatment of a patient, said timeline comprising one or more staff members assigned to the patient, one or more rooms in which the patient is to receive treatment, or both, wherein the one or more staff members initially comprise the selected staff member;
receive an indication of an actual assignment of a different staff member to the patient or room associated with the selected staff member; and
update the timeline in order to replace the selected staff member with the actual staff member, wherein the indication identifying the selected staff member as assigned to the room or patient previously displayed by the staff assignment application remains unchanged.

22. The system of claim 21, wherein in order to cause the display of and update a timeline associated with treatment of a patient, the patient tracking application is further configured, upon execution, to cause the display of and update a timeline on a first user device, and wherein in order to receive an indication of an actual assignment, the patient tracking application is further configured, upon execution, to receive the indication from a second user device different from the first user device.

23. A method comprising:
receiving a selection of one of a plurality of areas within a healthcare facility;
identifying one or more of a plurality of staff members capable of facilitating the treatment of a patient within the selected area;
receiving a selection of one of a plurality of peri-operative phases associated with treatment of a patient; and
enabling a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

24. The method of claim 23, wherein enabling a user to assign a selected one of the one or more identified staff members to facilitate treatment within the selected area in association with the selected peri-operative phase further comprises:
identifying one or more of a plurality of roles associated with the selected peri-operative phase;
determining which of the one or more identified roles the selected staff member is capable of performing; and
enabling the user to assign the selected staff member to facilitate treatment within the selected area in association with the selected peri-operative phase, only if it is determined that the selected staff member is capable of performing at least one of the one or more identified roles associated with the selected peri-operative phase.

25. The method of claim 24 further comprising:
enabling the user to assign one of the one or more identified roles to the selected staff member.

26. The method of claim 23, wherein enabling a user to assign a selected one of the one or more identified staff members to facilitate treatment within the selected area in association with the selected peri-operative phase further comprises:
receiving an identification of at least one of a room within the selected area or a patient receiving treatment within the selected area to which the selected staff member is to be assigned.

27. The method of claim 26 further comprising:
receiving an indication of a time frame for which one or more of the plurality of staff members are to be assigned to facilitate treatment within the selected area in association with the selected peri-operative phase.

28. The method of claim 27 further comprising:
identifying one or more patients receiving treatment within the selected area, in association with the selected peri-operative phase, and within the selected time frame, wherein in order to receive an identification of a patient receiving treatment within the selected area to which the selected staff member is to be assigned, the processor is further configured to receive a selection of one of the one or more identified patients.

29. The method of claim 26 further comprising:
causing the display of an indication identifying the selected staff member as assigned to the room or patient.

30. The method of claim 29 further comprising:
receiving an indication of an actual assignment of a different staff member to the room or patient associated with the selected staff member; and
generating, and causing to be displayed, in conjunction with the indication identifying the selected staff member as assigned to the room or patient, a second indication identifying the actual staff member assigned to the room or patient.

31. The method of claim 29 further comprising:
generating, and causing the display of, a timeline associated with the treatment of a patient, said timeline comprising one or more staff members assigned to the patient, one or more rooms in which the patient is to receive treatment, or both, wherein the one or more staff members initially comprise the selected staff member;
receiving an indication of an actual assignment of a different staff member to the patient or room associated with the selected staff member; and
updating the timeline in order to replace the selected staff member with the actual staff member, wherein the previously displayed indication identifying the selected staff member as assigned to the room or patient remains unchanged.

32. A computer program product comprising at least one computer-readable storage medium having computer-readable program code portions stored therein, said computer-readable program code portions comprising:
a first executable portion for receiving a selection of one of a plurality of areas within a healthcare facility;
a second executable portion for identifying one or more of a plurality of staff members capable of facilitating the treatment of a patient within the selected area;
a third executable portion for receiving a selection of one of a plurality of peri-operative phases associated with treatment of a patient; and
a fourth executable portion for enabling a user to assign a selected one of the one or more identified staff members to facilitate treatment within the selected area in association with the selected peri-operative phase, independent of an association between respective areas of the plurality of areas and respective peri-operative phases of the plurality of peri-operative phases and independent of an association between respective peri-operative phases and respective staff members of the plurality of staff members.

33. The computer program product of claim 32, wherein the fourth executable portion is further configured to:
identify one or more of a plurality of roles associated with the selected peri-operative phase;
determine which of the one or more identified roles the selected staff member is capable of performing; and
enable the user to assign the selected staff member to facilitate treatment within the selected area in association with the selected peri-operative phase, only if it is determined that the selected staff member is capable of performing at least one of the one or more identified roles associated with the selected peri-operative phase.

34. The computer program product of claim 33 further comprising:
a fifth executable portion for enabling the user to assign one of the one or more identified roles to the selected staff member.

35. The computer program product of claim 32, wherein the fourth executable portion is further configured to:
receive an identification of at least one of a room within the selected area or a patient receiving treatment within the selected area to which the selected staff member is to be assigned.

36. The computer program product of claim 35 further comprising:
a fifth executable portion for receiving an indication of a time frame for which one or more of the plurality of staff members are to be assigned to facilitate treatment within the selected area in association with the selected peri-operative phase.

37. The computer program product of claim 36 further comprising:
a sixth executable portion for identifying one or more patients receiving treatment within the selected area, in association with the selected peri-operative phase, and within the selected time frame, wherein in order to receive an identification of a patient receiving treatment within the selected area to which the selected staff member is to be assigned, the processor is further configured to receive a selection of one of the one or more identified patients.

38. The computer program product of claim 35 further comprising:
a fifth executable portion for causing the display of an indication identifying the selected staff member as assigned to the room or patient.

39. The computer program product of claim 38 further comprising:
a sixth executable portion for receiving an indication of an actual assignment of a different staff member to the room or patient associated with the selected staff member; and
a seventh executable portion for generating, and causing to be displayed, in conjunction with the indication identifying the selected staff member as assigned to the room or patient, a second indication identifying the actual staff member assigned to the room or patient.

40. The computer program product of claim 38 further comprising:
a sixth executable portion for generating, and causing the display of, a timeline associated with the treatment of a patient, said timeline comprising one or more staff members assigned to the patient, one or more rooms in which the patient is to receive treatment, or both, wherein the one or more staff members initially comprise the selected staff member;
a seventh executable portion for receiving an indication of an actual assignment of a different staff member to the patient or room associated with the selected staff member; and
a eighth executable portion for updating the timeline in order to replace the selected staff member with the actual staff member, wherein the previously displayed indication identifying the selected staff member as assigned to the room or patient remains unchanged.
